(19) United States
(12) Patent Application Publication
(10) Pub. No.: US 2018/0081320 A1
(43) Pub. Date: Mar. 22, 2018

(54) IMAGE FORMING SYSTEM AND METHOD FOR DRAWING OUT A POST-PROCESSING UNIT OF THE IMAGE FORMING SYSTEM

(71) Applicants: KABUSHIKI KAISHA TOSHIBA, Tokyo (JP); TOSHIBA TEC KABUSHIKI KAISHA, Tokyo (JP)

(72) Inventor: Yuichi SAITO, Numazu Shizuoka (JP)

(21) Appl. No.: 15/273,664

(22) Filed: Sep. 22, 2016

(51) Int. Cl. G03G 15/00

(52) U.S. Cl. CPC G03G 21/18; G03G 15/70

(57) ABSTRACT

An image forming apparatus has an internal discharge space for a sheet, that is located along a vertical axis between an image reading unit and an image forming unit, and first and second guides are installed in the internal discharge space. The first guide is configured to guide a post-processing unit from a first position within the internal discharge space, at which the post-processing unit receives a sheet discharged to the internal discharge space, to a second position within the sheet discharge space, which is downstream of the first position in a sheet discharging direction. The second guide is configured to guide the post-processing unit from the second position in a direction that crosses the guiding direction of the first guide. A moving distance of the post-processing unit from the first position to the second position is shorter than a total length of the post-processing unit in the guiding direction of the first guide.

### FIELD

This specification relates to an image forming system having an internal discharge space for discharging a sheet between an image reading unit and an image forming unit, and a method for drawing out a post-processing unit of the image forming system.

### BACKGROUND

In the related art, an image forming system having an internal discharge space for discharging a sheet between an image reading unit and an image forming units is known. In such an image forming system, a post-processing unit may be attached within the internal discharge space to perform a predetermined post-processing on the sheet discharged to the internal discharge space. When a paper jam occurs in the post-processing unit, the user needs to pull out the post-processing unit from the internal discharge space to remove a sheet jammed in the post processing unit. However, if the user pulls out the post-processing unit in a direction which is different from a sheet discharging direction, it may tear the jammed sheet or cause damage to internal parts such as conveying rollers if the sheet is jammed across the image forming unit and the post-processing unit.

Therefore, it is preferable to pull out the post-processing unit from the internal discharge space in the sheet discharging direction to prevent such damage to the sheet and the internal parts. In order to remove the jammed sheet from the post-processing unit, enough space for pulling out the post-processing unit from the internal discharge space in the sheet discharging direction needs to be secured around the image forming system. However, in general, a sufficiently wide area is not secured around the image forming system except at the front side of the image forming system.

### DESCRIPTION OF THE DRAWINGS

FIG. 1 is an external view of the configuration of an image forming system according to a first embodiment;

FIG. 2 is a conceptual view for explaining basic structures of a first guide and a second guide in the first embodiment;

FIG. 3 is a sectional view in an Y-Z plane seen from a direction parallel to the X axis showing a basic structure of the first guide and the second guide in the first embodiment;

FIG. 4 is a sectional view in an X-Z plane seen from a direction parallel to the Y axis showing a basic structure of the first guide and the second guide in the first embodiment;

FIG. 5 is a flow chart of an operation to remove a jammed sheet from the image forming system when sheet jam occurs in the first embodiment;

FIGS. 6-8 are each a conceptual view for explaining a movement of the first guide and the second guide;

FIG. 9 is a partially schematic perspective view for explaining basic structure of a post-processing unit in the first embodiment;

FIG. 10 is a partially schematic perspective view for explaining basic structure of a modified example of the post-processing unit in the first embodiment;

FIG. 11 is a conceptual view for explaining basic structures of a first guide and a second guide in an image forming system according to a second embodiment;

FIG. 12 is a partially sectional view in an Y-Z plane seen from a direction parallel to the X axis showing a basic structure of the first guide and the second guide in the second embodiment;

FIGS. 13 and 14 are each a conceptual view for explaining basic structures of a first guide and a second guide in an image forming system according to a third embodiment.

FIGS. 15 and 16 are each a conceptual view for explaining basic structures of a first guide and a second guide in an image forming system according to a fourth embodiment.

### DETAILED DESCRIPTION

According to an embodiment, there is provided an image forming apparatus having an internal discharge space for a sheet, the internal discharge space being located along a vertical axis between an image reading unit and an image forming unit, including a first guide; and a second guide. The first guide is configured to guide a post-processing unit from a first position within the sheet discharge space at which the post-processing unit receives a sheet discharged to the internal discharge space to a second position within the sheet discharge space which is downstream of the first position in a sheet discharging direction. The second guide is configured to guide the post-processing unit from the second position in a direction orthogonal to a guiding direction of the first guide. A moving distance of the post-processing unit from the first position to the second position is shorter than a total length of the post-processing unit in the guiding direction of the first guide.

According to another embodiment, there is provided an image forming system having an internal discharge space for a sheet, the internal discharge space being located along a vertical axis between an image reading unit and an image forming unit including: a post-processing unit; a first guide; and a second guide. The post-processing unit is configured to process a sheet discharged to the internal discharge space. The first guide is configured to guide the post-processing unit from a first position within the sheet discharge space at which the post-processing unit receives a sheet discharged to the internal discharge space to a second position within the sheet discharge space which is downstream of the first position in a sheet discharging direction. The second guide is configured to guide the post-processing unit from the second position in a direction orthogonal to a guiding direction of the first guide. A moving distance of the post-processing unit from the first position to the second position is shorter than a total length of the post-processing unit in the guiding direction of the first guide.

According to another embodiment, there is provided a method for drawing out a post-processing unit in an image forming system having an internal discharge space for a sheet, the internal discharge space being located along a vertical axis between an image reading unit and an image forming unit, including: guiding the post-processing unit from a first position within the sheet discharge space at which the post-processing unit receives a sheet discharged to the internal discharge space to a second position within the sheet discharge space which is downstream of the first position in a sheet discharging direction; and guiding the post-processing unit from the second position in a direction orthogonal to a guiding direction from the first position to the second position. A moving distance of the post-processing unit from the first position to the second position is shorter than a total length of the post-processing unit in the guiding direction thereof from the first position to the second position.

Embodiments are explained below with reference to the accompanying drawings.

### First Embodiment

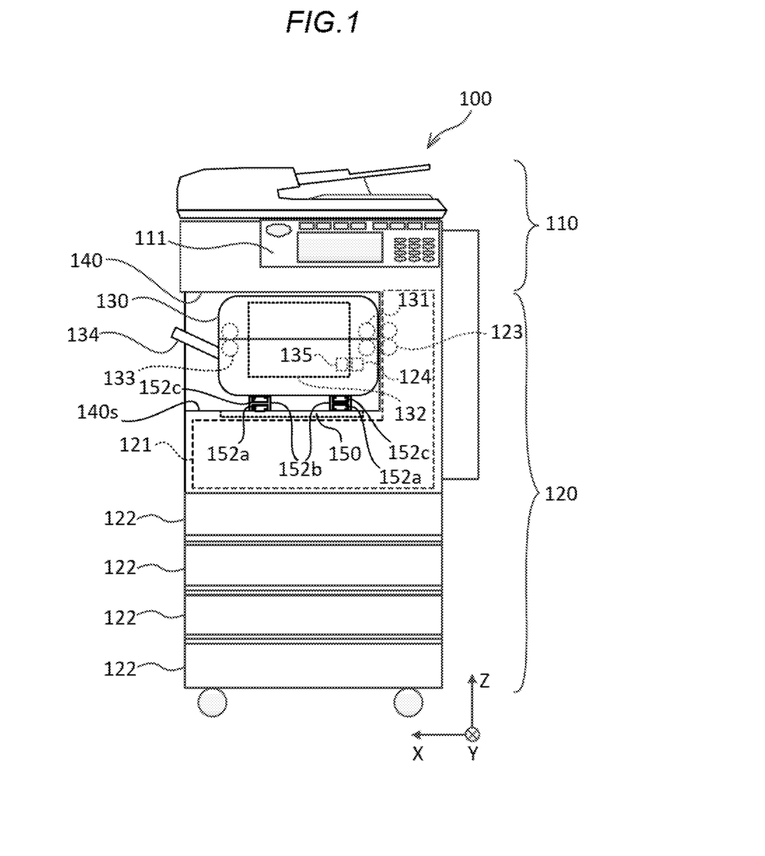

An image forming system according to a first embodiment is explained below. First, an image forming system including a post processing unit according to this embodiment is explained with reference to FIG. 1, which is an external view of a configuration of the image forming system according to the first embodiment. In FIG. 1, an X axis, a Y axis, and a Z axis are axes orthogonal to one another. The Z axis is an axis corresponding to an up-to-down direction of the image forming system. A relation among the three axes X, Y, and Z is the same in the other drawings.

An image forming system 100 includes an image reading unit 110, an image forming unit 120 and a post-processing unit 130.

The image reading unit 110 is positioned in a higher portion of the image forming system 100 in the Z axis direction. The image reading unit 110 is, e.g., a scanner, and performs the function of scanning to read images of a sheet.

The image forming unit 120 is positioned lower than the image reading unit 110 in the Z axis direction. The image forming unit 120 has an image forming section 121 in which an image is formed on a sheet with toner or ink, based on, for example, image data generated by the image reading unit 110 or image data transmitted from an external apparatus (e.g., a personal computer) to the image forming system 100. The sheet having the image formed thereon by the image forming section 121 is conveyed to paper discharge rollers 123 as will be further described below.

An operation panel 111 is used to input information concerning the operation of the image forming system 100 and includes a display unit. Paper feeding cassettes 122 can be inserted into a main body of the image forming system 100 (hereinafter referred to as an apparatus main body) and removed from the apparatus main body. The paper feeding cassettes 122 store sheets to be conveyed in the image forming unit 120 and to be subject to an image forming process in the image forming section 121. In this embodiment, plural paper feeding cassettes 122 are inserted into the apparatus main body.

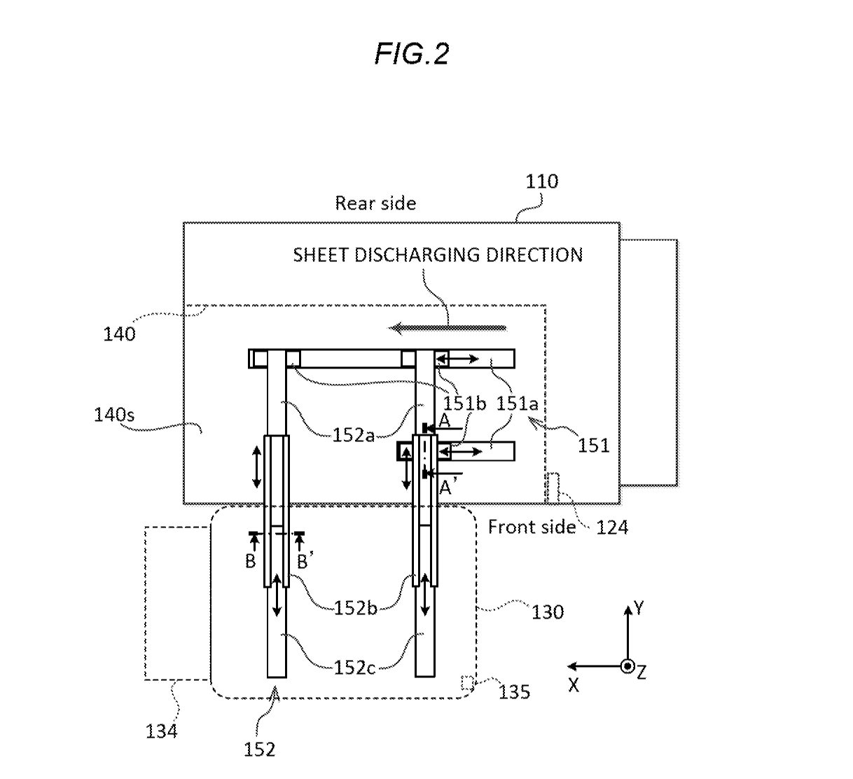

The apparatus main body of the image forming system 100 has an internal discharge space 140 (see FIG. 2) into which a sheet is discharged. The internal discharge space 140 is located between the image reading unit 110 and the image forming unit 120 in the Z axis direction.

The post-processing unit 130 is disposed in the internal discharge space 140 and is movable in the X axis direction and the Y axis direction in the internal discharge space 140 along guides of a guide mechanism 150. Details of the guide mechanism 150 are explained below. In this embodiment, for example, the guide mechanism 150 is disposed on a bottom surface 140s of the internal discharge space 140.

The post-processing unit 130 includes paper receiving rollers 131, a post-processing section 132, discharge rollers 133 and a paper discharge tray 134. The paper receiving rollers 131 receives a sheet discharged from the paper discharge rollers 123. The post-processing section 132 performs a required post-processing on the sheet or sheets received by the receiving rollers 131 based on, for example, an operation input made by the user (e.g., stapling, sorting, hole punching, folding, etc.). The discharge rollers 133 discharge the sheet processed by the post-processing section 132. The sheets discharged from the discharge rollers 133 are stacked on the paper discharge tray 134.

The structure of the guide mechanism 150 is explained below with reference to FIGS. 2 to 4.

The guide mechanism 150 includes a first guide 151 and a second guide 152. FIG. 2 is a conceptual view for explaining basic structures of the first guide 151 and the second guide 152 in the first embodiment.

The first guide 151 includes linear rails 151a and a plurality of sliders 151b that slide in the X axis direction and are guided by the linear rails 151a.

The second guide 152 includes a pair of linear rails 152b, a pair of first sliders 152a and a pair of second sliders 152c. Each of the first sliders 152a is guided by corresponding linear rail 152b. Further, each of second sliders 152c is guided by corresponding linear rail 152b.

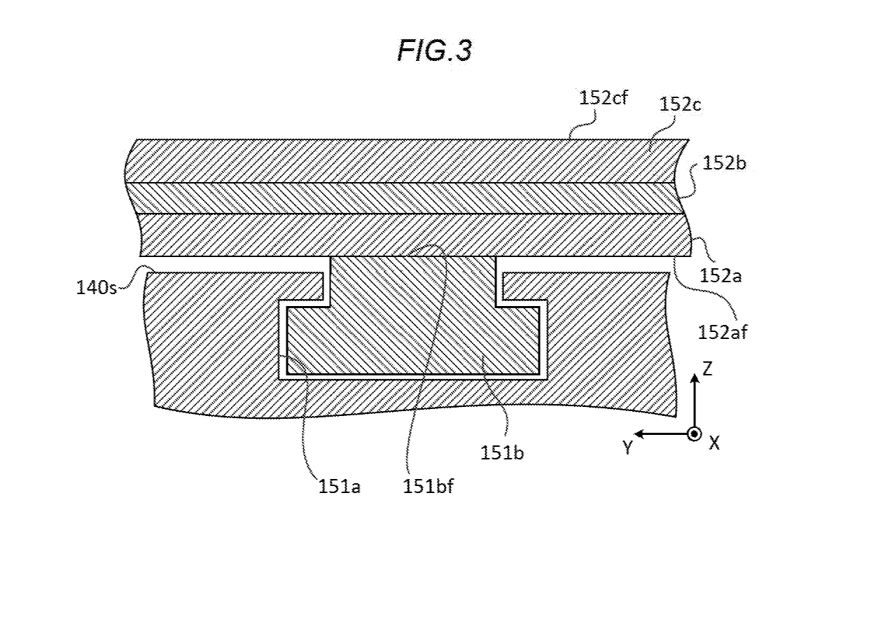

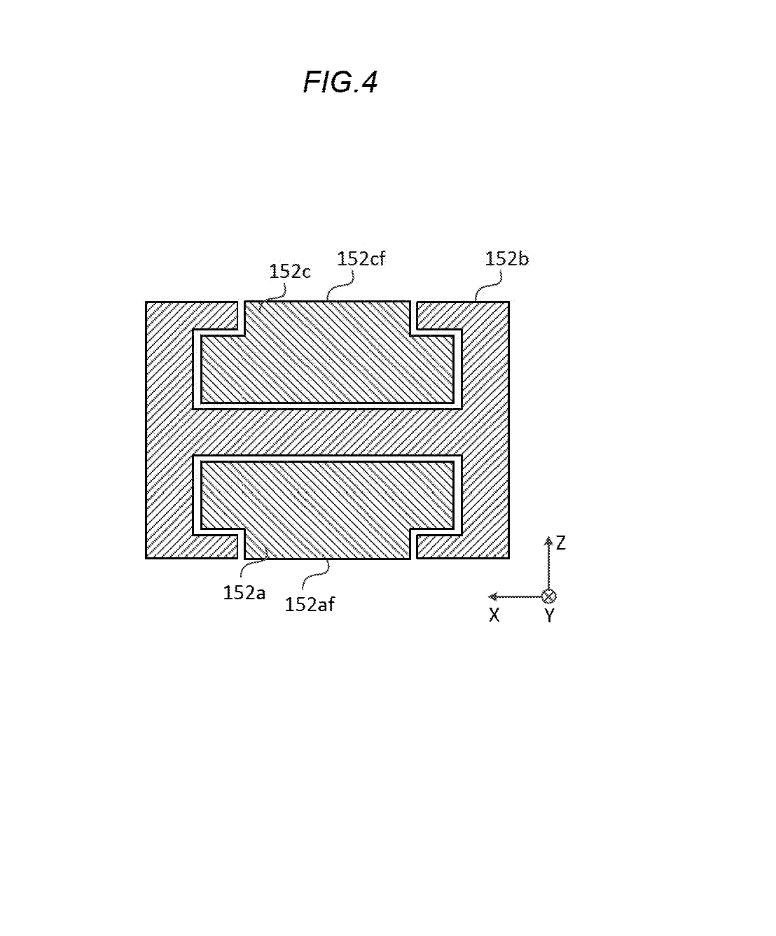

FIG. 3 is a sectional view taken along line A-A′ of FIG. 2 showing a basic structure of the first guide 151 and the second guide 152 in the first embodiment. FIG. 4 is a sectional view taken along line B-B′ of FIG. 2 showing a basic structure of the second guide in the first embodiment. Bottom surfaces 152af of the first sliders 152a are affixed to top surfaces 151bf of the sliders 151b so that the first guide 151 is able to guide the sliding of the sliders 151b in a direction that crosses (e.g., is perpendicular to) a guiding direction of the second guide 152. In addition, the first sliders 152a and the second sliders 152c are guided for movement in the Y direction by the corresponding linear rails 152b as shown in FIG. 4 and can each slide relative to the corresponding linear rail 152b in the Y axis direction.

The post-processing unit 130 is fixed on a predetermined area of top surfaces 152cf of the second sliders 152c. During operation, the second sliders 152c are fully drawn into the internal discharge space 140 so that the post-processing unit 130 is above the second sliders 152c, and the second sliders 152c are above the first sliders 152a.

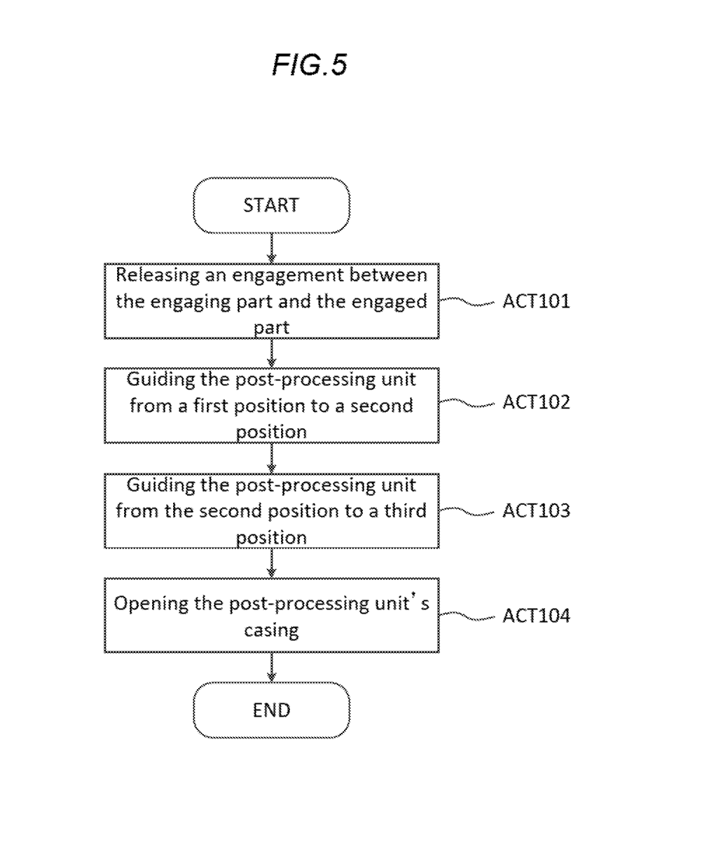

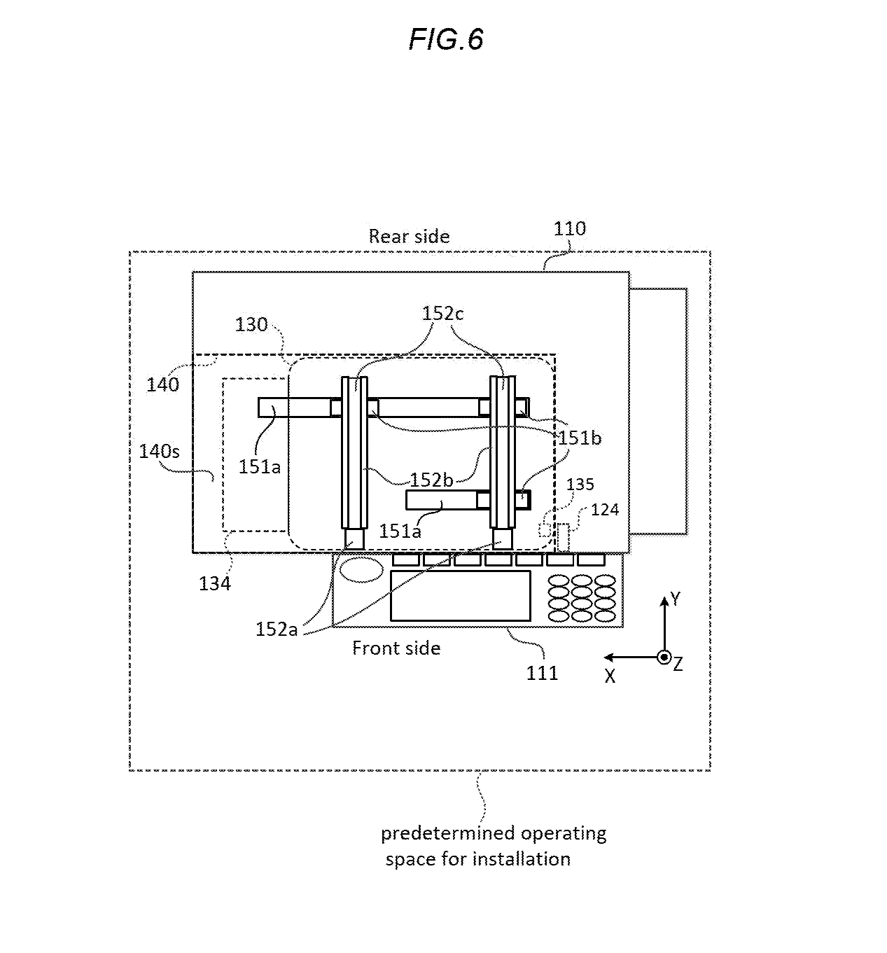

FIG. 5 is a flow chart of an operation to remove a jammed sheet from the image forming system 100 when a sheet jam occurs. During the operation, the user draws out the post-processing unit 130 from the apparatus main body, i.e., out of the internal discharge space 140. FIGS. 6 to 8 are conceptual views for explaining the movement of the first guide and the second guide in the first embodiment.

In FIG. 6, the post-processing unit 130 is at a first position to receive a sheet discharged to the internal discharge space 140 by the paper receiving rollers 131. The post-processing unit 130 has a first engaging part 135. At the first position, the first engaging part 135 of the post-processing unit 130 can be engaged with a corresponding second engaging part 124 of the apparatus main body. The second engaging part 124 and the first engaged part 135 can be engaging parts of any conventional engaging mechanism, e.g., an engaging member with an operating lever or screws. The user can release the engagement between the first engaging part 135 and the second engaging part 124 manually (ACT101).

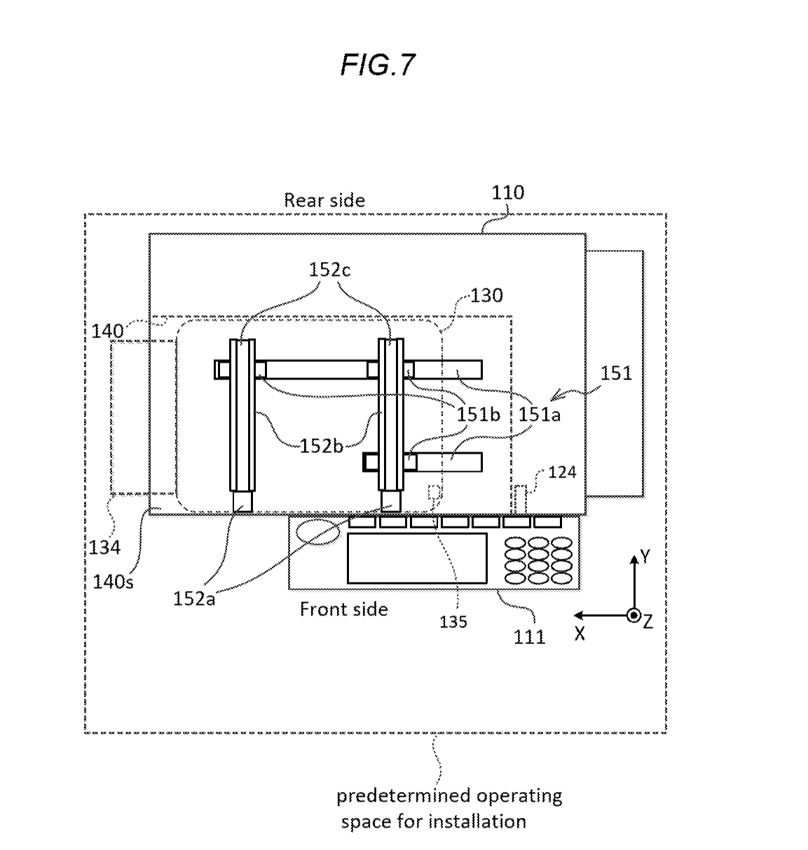

When the user releases the engagement, the user can manually slide the post-processing unit 130 from the first position (FIG. 6) to a second position (FIG. 7) using the first guide 151 (ACT102). FIG. 7 shows that the post-processing unit 130 is at the second position which is positioned downstream of the first position in a sheet discharging direction (X axis direction) within the sheet discharge space 140. As shown in FIG. 7, the main body of the post-processing unit 130 is still positioned within a footprint of the apparatus main body when the post-processing unit 130 is at the second position.

Further, a downstream end portion (here, downstream end of the paper discharge tray 134) in the sheet discharging direction (X axis direction) of the post-processing unit 130 at the second position is positioned further downstream of a downstream end of the image reading unit 110 in a sheet discharging direction, but is still positioned within a predetermined operating space around the image forming system 100.

Generally, the predetermined operating space is set around the image forming system 100 in order to secure space to do necessary operations including maintenance. Since such predetermined operating space need to be secured when installing the image forming system 100, it is not necessary to secure an additional space for the post-processing unit 130 at the second position.

By sliding the post-processing unit 130 from the first position to the second position, if a paper jam occurs, user can easily recognize whether there is a jammed sheet across the paper discharge rollers 123 and the paper receiving rollers 131 without risk of tearing the jammed sheet or causing serious damage to the paper discharge rollers 123 and paper receiving rollers 131. If the user finds any jammed sheet between the paper discharge rollers 123 and the paper receiving rollers 131 when the user slides the post-processing unit 130 from the first position to the second position, the user can easily remove such sheet.

Here, a moving distance of the post-processing unit 130 from the first position to the second position is shorter than the length of the post-processing unit 130 (including the paper discharge tray 134) in the moving direction thereof by the first guide 151 (X axis direction).

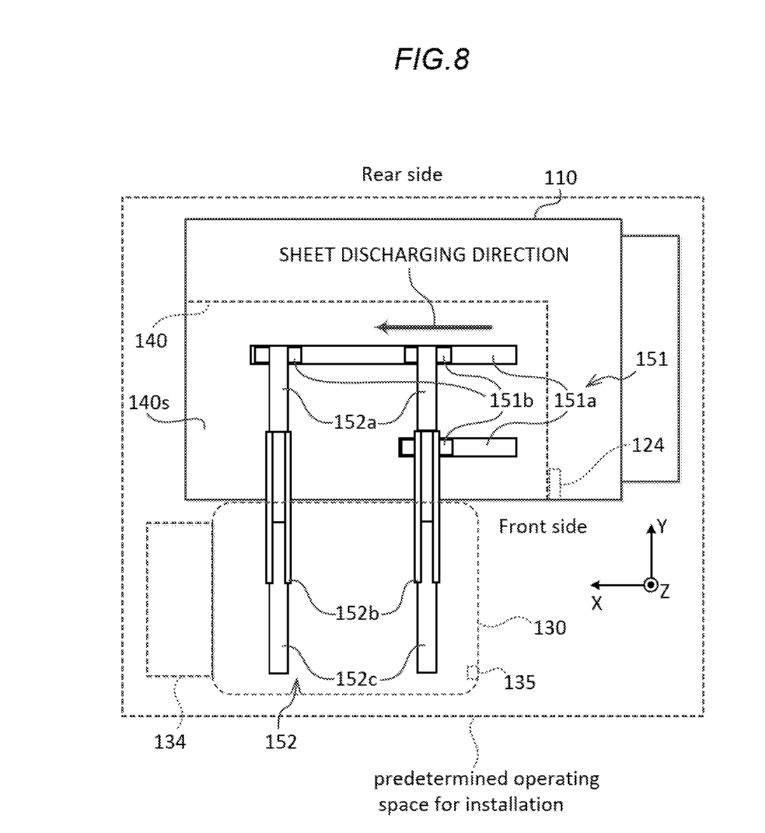

Subsequently, the post-processing unit 130 moved from the second position to a third position to remove a jammed sheet from an inside of the post-processing unit 130 (ACT103). In FIG. 8, the post-processing unit 130 is at the third position.

Specifically, the second guide 152 guides the post-processing unit 130 from the second position in a direction orthogonal to the moving direction between the first and second positions (X axis direction), toward a front side of the image forming system 100 that faces the user.

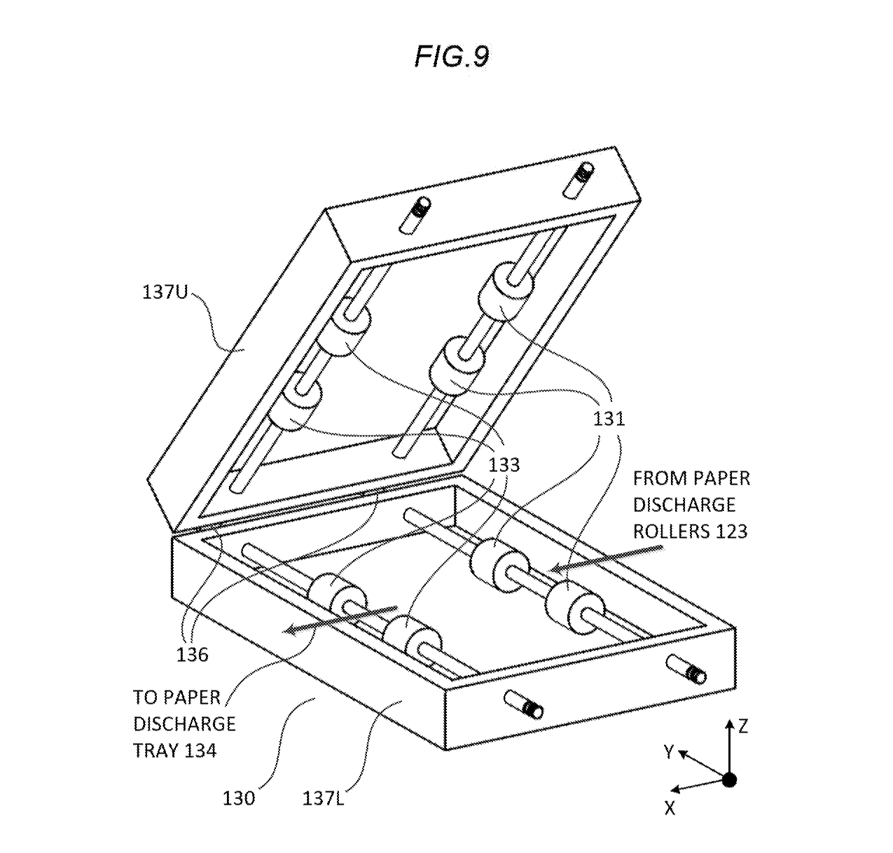

FIG. 9 is a partial schematic perspective view for explaining basic structure of a post-processing unit in the first embodiment. In FIG. 9, the processing section 132 is not shown to simplify the illustration.

In this embodiment, a casing of the post-processing unit 130 is openable so that a sheet jammed in the post-processing unit 130 can be removed from the post-processing unit 130. Specifically, the post-processing unit 130 has an upper casing 137U and a lower casing 137L. The upper casing 137U of the post-processing unit 130 opens with a rotational axis 136 that is parallel with a moving direction of the post-processing unit 130 by the first guide 151 (X axis direction), functioning as a fulcrum. By this structure, the user can open the casing of the post-processing unit 130 at the third position and remove the jammed sheet from the post-processing unit 130 (ACT104).

### <Modification>

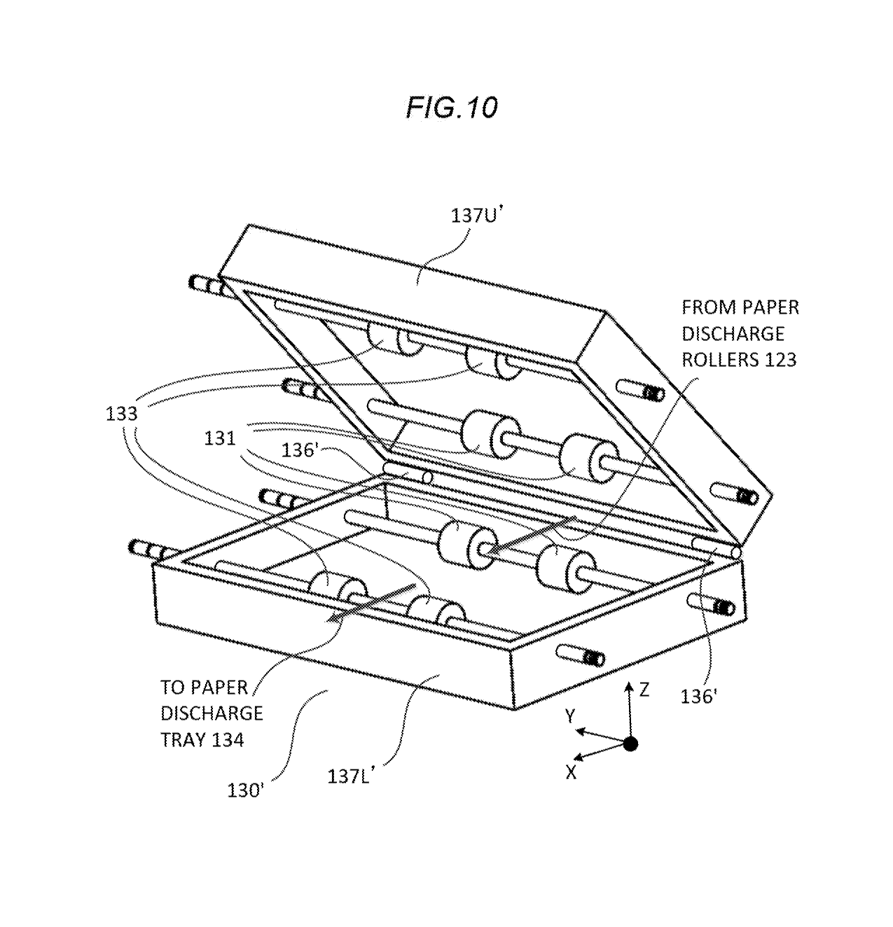

FIG. 10 is a partially schematic perspective view for explaining basic structure of a post-processing unit 130′ which is a further modification of the post-processing unit 130. In FIG. 10, the processing section 132 is not shown to simplify the illustration.

In this modification, a casing of the post-processing unit 130′ is openable so that a sheet jammed in the post-processing unit 130 can be removed from the post-processing unit 130′. Specifically, the post-processing unit 130′ has an upper casing 137U′ and a lower casing 137L′. The upper casing 137U′ opens with a rotational axis 136′ that is parallel with a moving direction of the post-processing unit 130′ by the second guide 152 (Y axis direction), functioning as a fulcrum.

According to the first embodiment, when a sheet jam occurs, it is possible to remove the jammed sheet from the image forming system 100 without tearing the jammed sheet or causing damage to the components of the post-processing unit 130 or 130′.

### Second Embodiment

An image forming system according to a second embodiment is explained below.

The second embodiment is a modification of the first embodiment. In the following description of the second embodiment, components having functions same as those explained in the first embodiment are denoted by the same reference numerals and signs, and explanation of such components is repeated as needed.

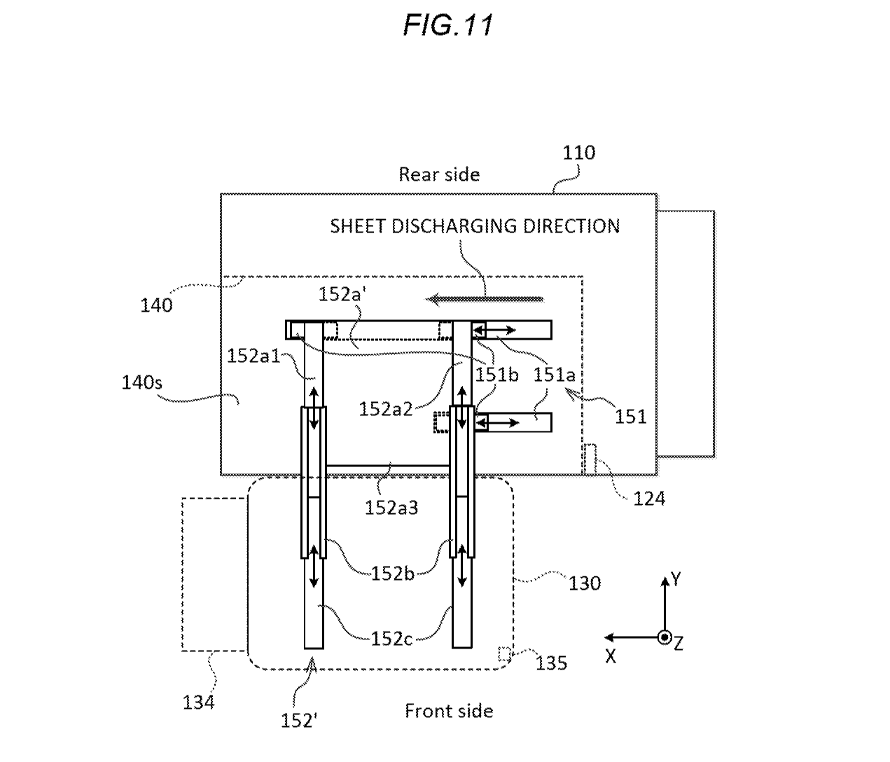

FIG. 11 is a conceptual view for explaining basic structures of a first guide and a second guide in a second embodiment.

As shown in FIG. 11, the second guide 152′ includes a first slider 152a′, a pair of linear rails 152b and a pair of second sliders 152c. Both of the linear rails 152b slide against the first slider 152a′ in the Y axis direction. Further, each of second sliders 152c is guided by corresponding linear rail 152b.

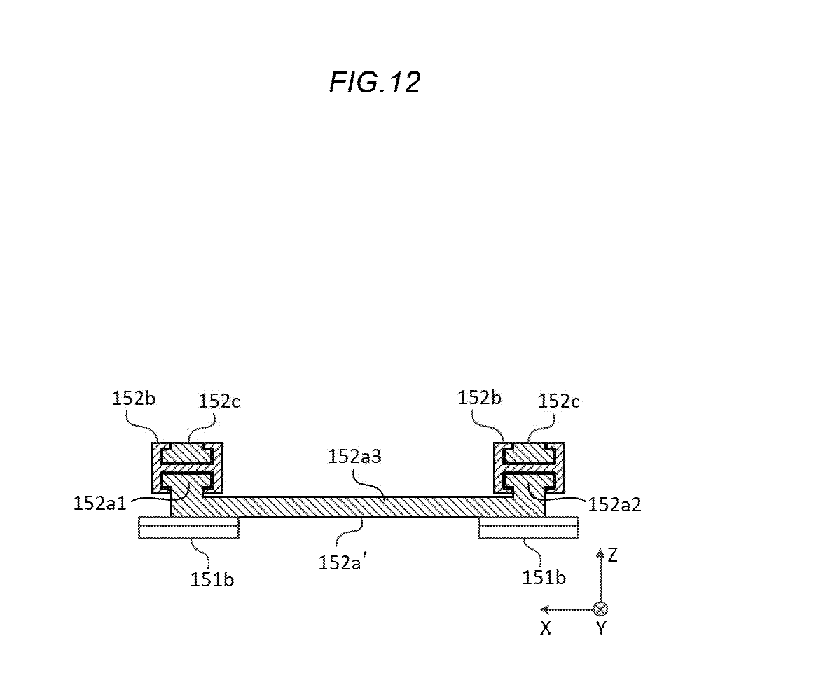

FIG. 12 is a partially sectional view in an X-Z plane seen from a direction parallel to the Y axis showing a basic structure of the first guide and a second guide in the second embodiment. As shown in FIG. 12, the second guide 152′ of the second embodiment has only one first slider 152a′ that includes a pair of guided portions 152a1 and 152a2 that are integrally formed with a planar portion 152a3. According to the second embodiment, a positional interrelationship between both of the linear rails 152b is stably fixed.

Further, by sharing a load from both of the linear rails 152b with the single first slider 152a′, concentration of the stress onto either one of the sliders 151b can be prevented.

### Third Embodiment

An image forming system according to a third embodiment is explained below.

The third embodiment is a modification of the first embodiment. In the following description of the third embodiment, components having functions same as those explained in the first embodiment are denoted by the same reference numerals and signs, and explanation of such components is repeated as needed.

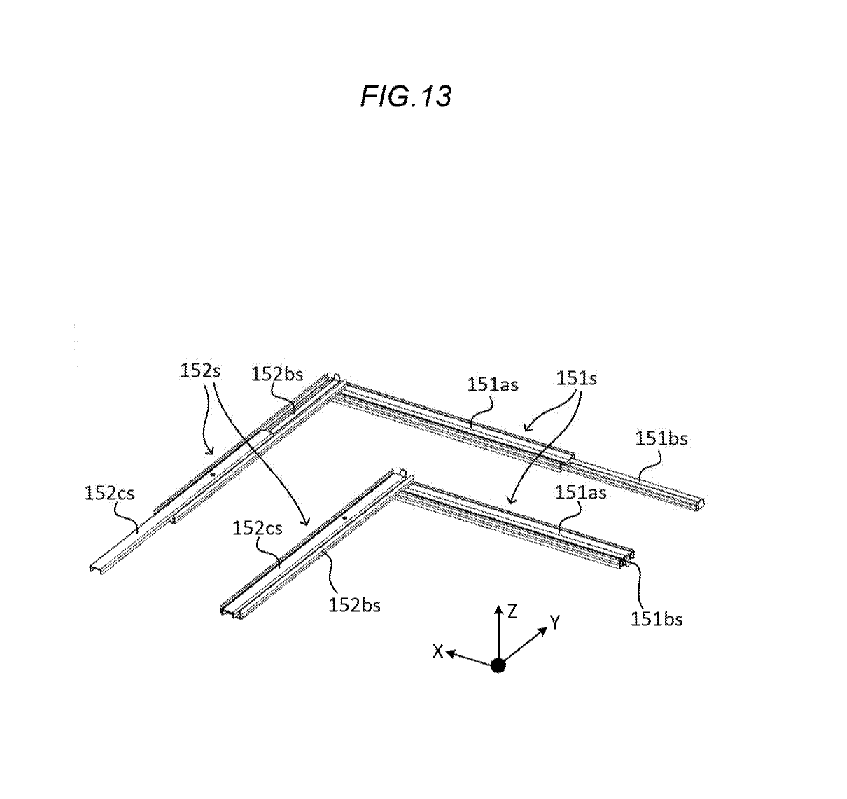

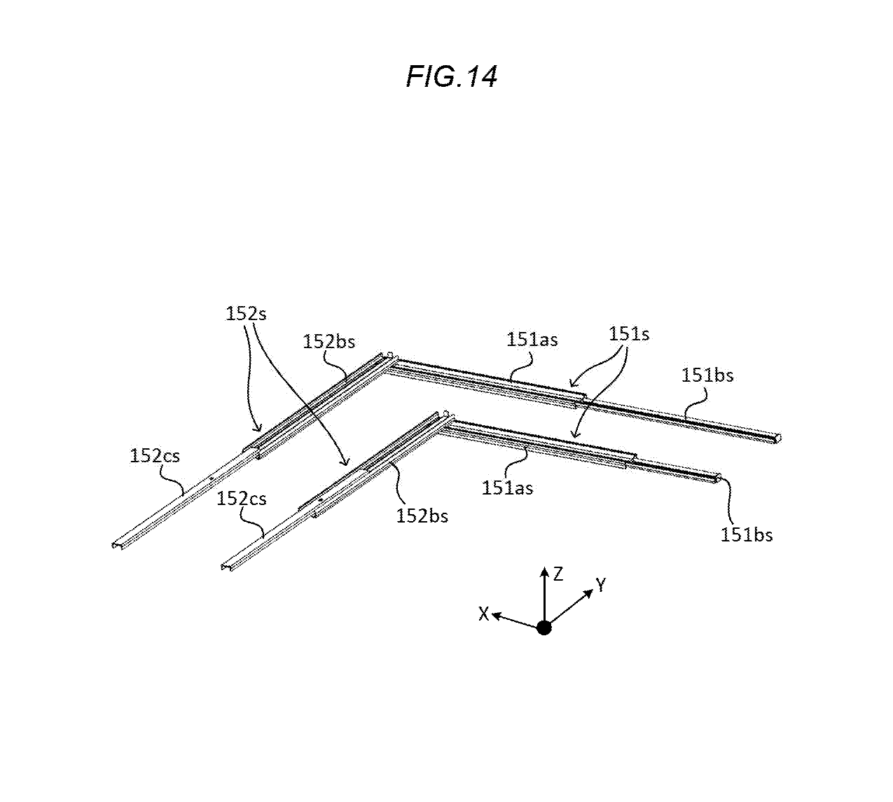

FIGS. 13 and 14 are each a conceptual view for explaining basic structures of a first guide 151s and a second guide 152s in an image forming system according to a third embodiment. FIG. 13 shows the positional relationship of each member of the first guide 151s and the second guide 152s when the post-processing unit 130 is at an operating position. FIG. 14 shows the positional relationship of each member of the first guide 151s and the second guide 152s when the post-processing unit 130 is at a drawn-out position.

In this embodiment, the first guide 151s includes a pair of linear rails 151bs and a pair of sliders 151as. The second guide 152s includes a pair of linear rails 152bs and a pair of sliders 152cs. Bottom surfaces of the linear rails 152bs are affixed to top surfaces of the sliders 151as so that the first guide 151s is able to guide the sliding of the sliders 151as in a direction that crosses (e.g., is perpendicular to) a guiding direction of the second guide 152s. In addition, the sliders 152cs are guided for movement in the Y direction by the corresponding linear rails 152bs as shown in FIG. 14.

The post-processing unit 130 is fixed on a predetermined area of top surfaces of the sliders 152cs. During operation, the sliders 152cs are fully drawn into the internal discharge space 140 so that the post-processing unit 130 is above the linear rails 152bs and above the linear rails 151bs.

### Fourth Embodiment

An image forming system according to a forth embodiment is explained below.

The fourth embodiment is a modification of the second embodiment. In the following description of the forth embodiment, components having functions same as those explained in the second embodiment are denoted by the same reference numerals and signs, and explanation of such components is repeated as needed.

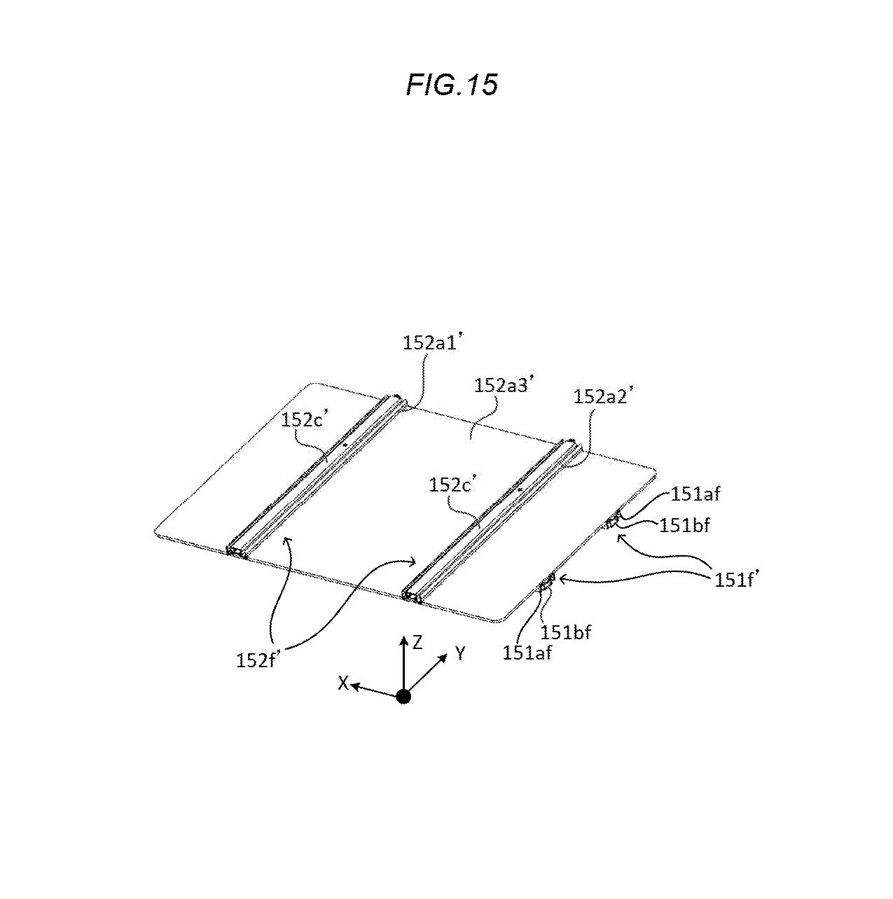

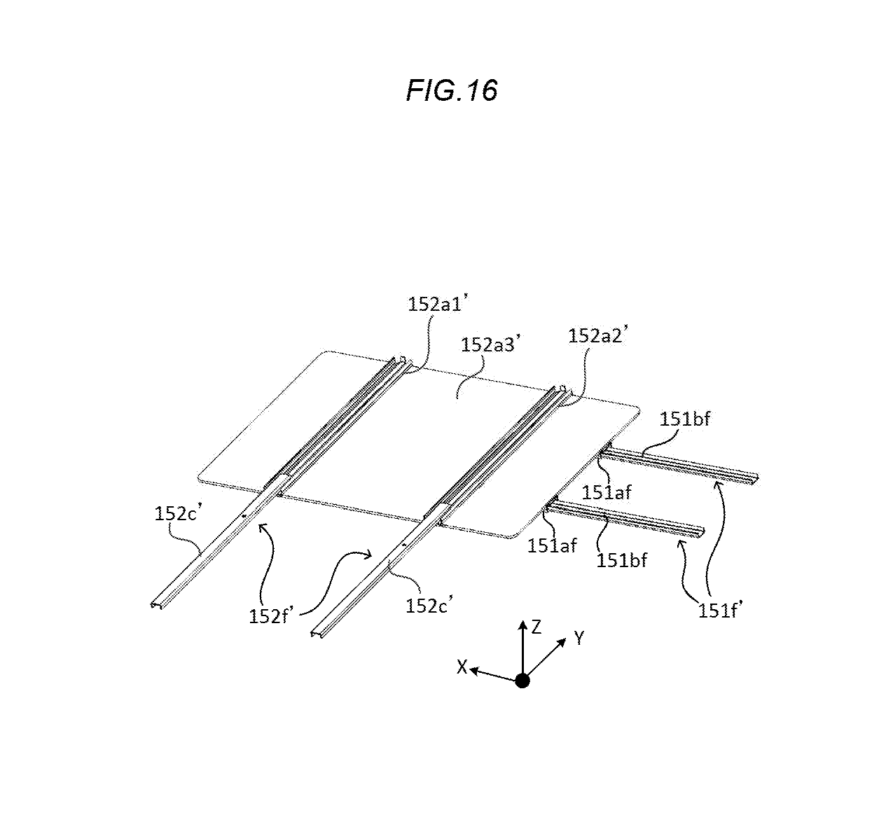

FIGS. 15 and 16 are each a conceptual view for explaining basic structures of a first guide and a second guide in an image forming system according to a fourth embodiment. FIG. 15 shows the positional relationship of each member of the first guide and the second guide when the post-processing unit 130 is at an operating position. FIG. 16 shows the positional relationship of each member of the first guide 151f′ and the second guide 152f′ when the post-processing unit 130 is at a drawn-out position.

As shown in FIGS. 15 and 16, the second guide 152f′ includes a pair of sliders 152c′, a planar portion 152a3′ and a pair of linear rails 152a1′ and 152a2′. The pair of linear rails 152a1′ and 152a2′ are integrally formed with the planar portion 152a3′. Each of the linear rail 152a1′ and the linear rail 152a2′ guides the sliding of the corresponding slider 152c′ in the Y-axis direction.

Sliders 151af are affixed to a predetermined area of bottom surface of the planar portion 152a3′. The sliders 151af are guided by a pair of linear rails 151bf in the X-axis direction.

The post-processing unit 130 is affixed to a predetermined area of top surfaces of the sliders 152c′. During operation, the sliders 152c′ are fully drawn into the internal discharge space 140 so that the post-processing unit 130 is above the linear rails 152a1′ and 152a2′.

According to the fourth embodiment, a positional interrelationship between both of the linear rails linear rails 152a1′ and 152a2′ is stably fixed.

In the above embodiments, the post-processing unit is completely outside the footprint of the image forming system at the third position. However it is possible to position the post-processing unit partially inside the footprint of the image forming system if the post-processing unit can be opened properly for removing a sheet as a result.

In the above embodiments, the post-processing unit is guided by multiple guiding members of the first guide. However it is possible to use a single guiding member to guide the post-processing unit in the guiding direction of the first guide.

In the above embodiments, the post-processing unit is guided by multiple guiding members of the second guide. However it is possible to use a single guiding member to guide the post-processing unit in the guiding direction of the second guide.

The present invention can be carried out in various forms without departing from main characteristics thereof. The embodiments are merely exemplars in every aspect and should not be limitedly interpreted. The scope of the present invention is indicated by the scope of claims. The text of the specification does not restrict the scope of the invention. All variations and various improvements, alterations, and modifications belonging to the scope of equivalents of the scope of claims are within the scope of the present invention.

What is claimed is:

1. An image forming apparatus having an internal discharge space for a sheet, the internal discharge space being located along a vertical axis between an image reading unit and an image forming unit, comprising:
a first guide configured to guide a post-processing unit from a first position within the sheet discharge space at which the post-processing unit receives a sheet discharged to the internal discharge space to a second position within the sheet discharge space which is downstream of the first position in a sheet discharging direction; and
a second guide configured to guide the post-processing unit from the second position in a direction orthogonal to a guiding direction of the first guide,
wherein a moving distance of the post-processing unit from the first position to the second position is shorter than a total length of the post-processing unit in the guiding direction of the first guide.

2. The apparatus according to claim 1, wherein
a main body of the post-processing unit is positioned within a footprint of the image forming apparatus when the post-processing unit is at the second position.

3. The apparatus according to claim 1, wherein
the second guide guides the post-processing unit from the second position to a third position at which a jammed sheet can be removed from the post-processing unit.

4. The apparatus according to claim 1, wherein
a downstream end portion of the post-processing unit at the second position in the sheet discharging direction is positioned within a predetermined operating space around the image forming apparatus.

5. The apparatus according to claim 1, wherein
a casing of the post-processing unit is openable so that a sheet jammed in the post-processing unit can be removed from the post-processing unit, and
the casing opens when an upper part thereof rotates about an axis that is parallel to the guiding direction of the first guide.

6. The apparatus according to claim 1, wherein
a casing of the post-processing unit is openable so that a sheet jammed in the post-processing unit can be removed from the post-processing unit, and
the casing opens when an upper part thereof rotates about an axis in that is parallel to a guiding direction of the second guide.

7. An image forming system having an internal discharge space for a sheet, the internal discharge space being located along a vertical axis between an image reading unit and an image forming unit, comprising:
a post-processing unit configured to process a sheet discharged to the internal discharge space;
a first guide configured to guide the post-processing unit from a first position within the sheet discharge space at which the post-processing unit receives a sheet discharged to the internal discharge space to a second position within the sheet discharge space which is downstream of the first position in a sheet discharging direction; and
a second guide configured to guide the post-processing unit from the second position in a direction orthogonal to a guiding direction of the first guide,
wherein a moving distance of the post-processing unit from the first position to the second position is shorter than a total length of the post-processing unit in the guiding direction of the first guide.

8. The system according to claim 7, wherein
a main body of the post-processing unit is positioned within a footprint of the image forming system when the post-processing unit is at the second position.

9. The system according to claim 7, wherein
the second guide guides the post-processing unit from the second position to a third position at which a jammed sheet can be removed from the post-processing unit.

10. The system according to claim 7, wherein
a downstream end portion of the post-processing unit at the second position in the sheet discharging direction is positioned within a predetermined operating space around the image forming system.

11. The system according to claim 7, wherein
a casing of the post-processing unit is openable so that a sheet jammed in the post-processing unit can be removed from the post-processing unit, and
the casing opens when an upper part thereof rotates about an axis that is parallel to the guiding direction of the first guide.

12. The system according to claim 7, wherein
a casing of the post-processing unit is openable so that a sheet jammed in the post-processing unit can be removed from the post-processing unit, and
the casing opens when an upper part thereof rotates about an axis in that is parallel to a guiding direction of the second guide.

13. A method for drawing out a post-processing unit in an image forming system having an internal discharge space for a sheet, the internal discharge space being located along a vertical axis between an image reading unit and an image forming unit, comprising:
guiding the post-processing unit from a first position within the sheet discharge space at which the post-processing unit receives a sheet discharged to the internal discharge space to a second position within the sheet discharge space which is downstream of the first position in a sheet discharging direction; and
guiding the post-processing unit from the second position in a direction orthogonal to a guiding direction from the first position to the second position,
wherein a moving distance of the post-processing unit from the first position to the second position is shorter than a total length of the post-processing unit in the guiding direction thereof from the first position to the second position.

14. The method according to claim 13, wherein
a main body of the post-processing unit is positioned within a footprint of the image forming system when the post-processing unit is at the second position.

15. The method according to claim 13, wherein
when guiding the post-processing unit from the second position in the direction orthogonal to the moving direction, guiding the post-processing unit from the second position to a third position at which a jammed sheet can be removed from the post-processing unit.

16. The method according to claim 13, wherein
a downstream end portion of the post-processing unit at the second position in the sheet discharging direction is positioned within a predetermined operating space around the image forming system.

17. The method according to claim 13, wherein
a casing of the post-processing unit is openable so that a sheet jammed in the post-processing unit can be removed from the post-processing unit, and
the casing opens when an upper part thereof rotates about an axis that is parallel to the guiding direction of the post-processing unit from the first position to the second position.

18. The method according to claim 13, wherein
a casing of the post-processing unit is openable so that a sheet jammed in the post-processing unit can be removed from the post-processing unit, and
the casing opens when an upper part thereof rotates about an axis in that is parallel to a guiding direction of the post-processing unit from the second position in a direction orthogonal to a guiding direction from the first position to the second position.
